(19) United States
(12) Patent Application Publication
(10) Pub. No.: US 2007/0089357 A1
(43) Pub. Date: Apr. 26, 2007

(54) Integrated method to implement a single pallet landscaping system, and its extension

(76) Inventor: Raymond Pearson Bowdish, Lisbon, NY (US)

Correspondence Address: Raymond Pearson Bowdish, 213 Lawrence Road, Lisbon, NY, 13658, US

(21) Appl. No.: 11/258,630

(22) Filed: Oct. 26, 2005

(51) Int. Cl. A01G 9/00

(52) U.S. Cl. 47/18

(57) ABSTRACT

An improved method is disclosed for optimizing the use of a single portable platform component in landscaping and related activities involving intentional horticultural structures. The inventive technique utilizes the full modularity and compartmentalization capabilities of the portable platform component in activities involving the design, installation and maintenance of intentional horticultural structures. The inventive technique also employs a template specification to organize and store all information relevant to the structure. An orderly set of well defined steps are suggested to optimize the benefits derived from the inherent modularity of the platform component employed in well integrated processes. These steps also permit the maximum advantage to be made of the template specification in organizing and guiding the design, installation and maintenance processes. These combined and separate methods provide for greater optimization with respect to all the resources and constraints associated with the design. installation and maintenance of any intentional horticultural structure.

### CROSS-REFERENCE TO RELATED APPLICATIONS

Not Applicable

### FEDERALLY SPONSORED RESEARCH

Not Applicable

### INCORPORATION-BY-REFERENCE OF MATERIAL SUBMITTED ON A COMPACT DISC, SEQUENCE LISTING, OR PROGRAM

Not Applicable

### BACKGROUND OF INVENTION

1) Field of Invention

This invention relates to methods for use in the design and installation and maintenance of intentional horticultural structures. Specifically, it relates to modular methods utilizing a generalized portable platform element as a component that is appropriate for employment as a container and transport device for vegetative and possibly additional elements to be installed in such a structure. More specifically, it relates to optimized and integrated methods for utilizing any number and type of such components employed in this manner.

2) Description of Related Art

Landscaping, or more correctly, landscape architecture, involves the alteration of the aesthetic or pragmatic (purely functional) properties of a location through augmentation, removal or excavation, or rearrangement of the physical elements associated with the location in a planned or orderly manner. Landscaping may involve aquatic elements, or may consist entirely of agriculture suspended within a water environment. Landscapes may coexist with or within habitats and related structures as integrated or temporary elements. Modern landscaping techniques have been developed primarily to take advantage of the compartmentalization and modularity that characterize any approach to a landscaping project. The choice of a location, distinguished by its selection from its larger context and yet still contained within that context, is the largest compartmentalization or module definition. The individual plants and their containers, and other features are accessory elements. They contribute to the compartmentalization of the physical location into smaller modules or collections of modular elements, including individual or collective vegetative elements. Containers may also be composed of or may include additional or finer partitioning and compartmentalization. Complex tasks or installations are generally analyzed and broken down into smaller units, permitting for more efficient use of labor, materials, time, and other resources while remaining within any constraints on these resources. The incorporation of additional modularity and modular techniques into landscaping at all levels of complexity is not a priori the best approach to a particular problem or landscaping project. Modularity is one tool that may provide for greater optimization of the entire design or installation or maintenance process. Like all tools it is subject to the constraints and resources that determine how successfully the intent of the horticultural structure may be realized. The advancement of modular techniques and tools requires that they provide for the more complete integration of such tools and methods into the art. This, in turn, requires that the individual tools be used to their maximum advantage. Extending or improving the individual tools combined with improved integration into the art logically and inevitably provide more options to both the designer and the engineer. This increase in flexibility translates into greater possibilities for optimization of the process based upon the intent of the design, with less constraint on the approach chosen to implement the design.

Traditional intentional horticultural structures, which we may call “gardens” without implying any loss of generality, include the use of three basic types of plantings: those in human-made containers, those in “raised bed” type structures and those in the soil of the natural landscape. The natural landscape has been seen to have a modular nature in the context of design and installation and maintenance of a garden. Individual plants or plant groupings may be considered as modular elements in that they compartmentalize the visible area in which they are considered to be contained, either by isolating themselves in some way or by harmonizing with the local environment. Plant containers, which include any vessel used to isolate root systems, are inherently modular. They are frequently used in horticultural landscape designs and are usually constructed from durable materials like stone, pottery, wood, reeds, plastic, metal etc and they can be shaped into urns, window boxes, pots, or barrels for example. The permanence of a container tends to increase with an increased size of containers. Thus a vegetative element within a container becomes an architectural element at some point where its absence alters the overall theme of a completely unique architectural unit; usually some structural significance is attached to the “container” that is considered an architectural element. Outdoor “bed style” plantings or architectural elements within, around and on buildings are only plant containers if the soil that they contain is isolated from the soil of the natural landscape. Raised bed plantings are generally not considered plant containers as they are usually constructed with sides and no bottom.

The bulk of landscape designs are created by plantings in the soil without side supports. These plantings are usually created using horticultural varieties (propagated inside plant nurseries and greenhouses) that are ultimately removed from their propagation containers and grown in soil beds. From the plant varieties available landscape designers make decisions concerning inherent life cycles and growth habits and the aesthetic appeal of individual plants to fill said designs with plant varieties that suit the climate or any other aspect of an environment or of design intent. Plant containers used by horticulturalists are created from durable, semi-durable or non-durable materials; the latter including materials like burlap plastic netting and Texel® fabric. This provides them with a broader range of possible uses and thus increases the possibilities for optimization of the entire structure of which they become a part.

Plants used as transplants in a modern landscape are usually grown individually to discourage intraspecific competition. Trees, shrubs and perennials are often grown with specific spacing in field situations then their root systems are removed and “balled” in burlap or similar materials. Modern landscape designs are thus, a combination of individually grown nursery or greenhouse grown plants (bulbs, annuals flowers and grasses, perennials, herbs, vegetables, shrubs and trees) planted into garden beds or containers that follow the design intent of a landscape architect. Plantings may be interfaced or integrated with indigenous plant genotypes and extant landscape features but often they are exclusively horticultural plant varieties.

A pallet is generally defined in terms of a durable, reusable rectangular platform with vertical sides possessing a horizontal load-bearing surface and fabricated with means or attachment for movement or transport. The transport will usually require some means of mechanical advantage for a pallet under load. Within horticultural applications, e.g. landscaping or horticultural architecture, pallets exist to provide a standardized substrate area that is easily adapted for use in creating components for any landscape design module that does not require an area or load capacity greater than that of the pallet They provide the facility to efficiently and effectively grow the vegetative elements of a landscaping or garden project at a remote location under controlled conditions in an organized manner for later transport to and installation into the garden. The realization that this transport element could be modified and integrated into landscaping as a functional and design element has led to a revolution in techniques and tools. Pallets, which have been modified to supply a surface capable of supporting soil, or some other growth media, have become an important element in modern landscaping.

The simplest mode in which pallets are employed in the design and installation and maintenance of gardens involves stacking or ordering other primarily modular elements and accessory elements e.g. plants in or out of containers, statues, pillars, fountains, lighting units, bricks, etc, on pallets for transport in an orderly and efficient and reusable way to facilitate their transportation, storage, assembly and installation. In this mode, it is the simple, efficient, effective and identical nature of the pallets that make them so valuable, i.e., which defines their place in the modularity of the larger process. This mode requires essentially no real aesthetic or pragmatic choices involving prior fabrication or post-fabrication modifications. The actual size and materials of a pallet may vary, but the basic use is unchanged.

Modern horticulture has developed a more advanced use of the pallet, which requires, fundamentally, only one major structural modification. The pallet is prepared or prefabricated so that some or its entire horizontal surface is able to retain and support the growth media and at least some of the vegetative matter, which will constitute the finished garden. Preparation in this way transforms the pallet into a modular portable platform component. Most implementations of this mode use specially modified or fabricated pallets to prepare, grow and assemble large tiled regions of turf or similar material. The pallet definition may be readily extended to include components of non-rectangular, or even non-regular, shape and non-horizontal, multi-compartment, non-contiguous media bearing surfaces. Examples of these have been included in the Drawings. The most important factor in determining the physical and functional appearance of the pallets to be used is again a matter of optimization. The best shape at the least cost for the most efficiency, etc, ensures that the intent of the horticultural structure is satisfied under the constraints and within the resources associated with it. The literature in the art as reviewed supports only applications in which the portable horticultural platform is a single member of a plurality of identical or near-identical units combined rigidly or non-rigidly into coordinated aggregate structures. It is this use that accounts for almost all of the development of the pallet in horticulture to date as a tool for landscaping. This mode also relies upon the simple, efficient, effective and identical nature of the pallets employed in any project or installation, which defines their place in the modularity of the larger process.

The third and final mode for implementing the pallet as a portable platform component provides for complete implementation of the modularity inherent within any such component of a horticultural structure. This requires that the full compartmentalization of the pallet be exploited in a simple and adaptable way. This will provide for the greatest possible flexibility with the minimum of prior fabrication or planning. In this mode it is the aesthetic and pragmatic functionality of the individual pallet that defines its place within the modularity of the larger process. This mode has to date been implemented only in partial and restricted ways as represented in the literature of the art. All of these implementations require a multiple (more than one) pallet platform of the type developed or described in order to faithfully implement the design intent of the unit. It is also important to note that to date there is no proposed or actual general method available for reference which provides for an integrated and adaptable approach to implementing portable platforms within a generalized design and installation and maintenance process for a generic intentional horticultural structure which both utilizes the unrestricted modularity of the pallet (mode 3) and provides the possibility of using this potential to assist in optimizing the design and installation and maintenance of an horticultural structure with respect to all the constraints and resources associated with the process.

3) Objects and Advantages of the Inventive Technique

The present invention is concerned with the implementation of modular methods based upon the implementation of a portable platform component in the design and installation and maintenance of intentional horticultural structures. When the techniques described are used individually or cooperatively they provide the means for a desired, but to date unrealized, degree of optimization with respect to all constraints and resources that influence the design and installation and maintenance processes.

An object of the present invention is to use these techniques to enhance and extend the surface compartmentalization designed for supporting and retaining growth media, vegetative elements, and possibly accessory elements associated with any portable platform component utilized. This method comprises the insertion, placement of or covering by conformable or rigid non-prefabricated, non-vegetative elements to form new compartmentalization or increased modularity or new aesthetic or pragmatic functionality beneath or within or upon the media supported or contained on the surface of the platform. This method amounts to an extension of the full modularity of the intentional structure, which in turn provides greater optimization in the form of increased design and installation and maintenance options within the limits set by the constraints and resources associated with the processes.

Another object of the present invention is to use these techniques to enhance the efficiency and economy associated with the design and installation and maintenance of intentional horticultural structures through the use of a template or design guide integrated in part or in full either: into the surface of the growth media retained and supported by any portable platform component utilized, or into the mulch, fabric, coating or other possibly growth influencing surface covers provided or intended for use over the growth media and residing between or among the media and any surface elements, or possibly into a non-integrated, reusable template sheet or cover as may presently exist in the art, or possibly into some combination of these techniques. This method amounts to a technique to optimize the inventory, fabrication costs, labor expenses and other resources and constraints influencing the choice, assembly and use of any particular portable platform component in realizing the intent of the horticultural structure.

According to one aspect of the invention, it provides a method for storing or remembering all information necessary to assemble or install portable platform components and all other modular or non-modular elements according to a template or template-like procedure so that the information may be recalled at any time and for any design or installation or maintenance of any intentional horticultural structure. This method amounts to a design specification, or more accurately, a template specification for the design, of the intentional structure. This method provides for a greater integration of modular techniques into the design and installation and maintenance of horticultural structures by providing a dynamic method to add, delete, or to modify both the modular and integrated aspects represented within the intentional structure in an optimal manner, that is, with minimal interference with existing or intended aesthetic or pragmatic elements and arrangements and with a maximal ability to account for the constraints and resources affecting the design and installation and maintenance.

According to another aspect of the invention, it provides a method to develop processes that permit for greater optimization of the design and installation and maintenance of intentional horticultural structures. This method amounts to an integrated and iterative, possibly minimally ordered set of well-defined individual steps which in a separate or combined manner provide for exploiting the full modular and integrated aspects inherent in any such process leading to an increase in the possible optimization within any approach to implement any portable platform component within the design and installation and maintenance of any intentional horticultural structure subject to the constraints and resources associated with the structure.

### BRIEF SUMMARY OF THE INVENTION

In accordance with the present invention it is required that the design and installation and maintenance of an intentional horticultural structure proceed from a process which employs (a) portable platform component(s) and in which this component or these components have been employed with respect to the maximal modularity inherent in their fabrication method and materials, particularly with respect to that provided by the potential compartmentalization of the surface and volume of the growth media supported and retained by any such component's surface. It is recommended that the processes associated with the design and installation and maintenance of the intentional horticultural structure proceed through the facility of template or templates inserted or embossed or embroidered or marked or otherwise incorporated under or within or on the media supported and retained by the portable platform component, or inserted or embossed or embroidered or marked or otherwise incorporated into a mulch or cover of fabric or other materials placed over the media retained and supported by the component, or inserted or embossed or embroidered or marked or otherwise incorporated into a reusable, possibly removable cover according to the art, or inserted or embossed or embroidered or marked or otherwise incorporated in a combination of some or all of these template-like inclusions. It is further recommended that the processes associated with the design and installation and maintenance of the intentional horticultural structure proceed through the creation or assembly or employment of a template specification which may provide for the assembly or construction of templates for the entire structure or for any modularity or any existing or desired or former internal compartmentalization or modularity of the structure, and where the specification so created or assembled may be remembered or recalled in a non-volatile manner. It is finally recommended that the processes associated with the design and installation and maintenance of an intentional horticultural structure proceed according to a specific set of individual steps in a possibly non-sequential but ordered manner. It is expected that a process that proceeds in accord with these recommendations will be characterized by increased optimization with respect to all the constraints and resources associated with the structure and the process employed.

### BRIEF DESCRIPTION OF THE SEVERAL VIEWS OF THE DRAWINGS

FIG. 1A is an exploded perspective view of a generalized portable platform component constructed from base pallet extended with plastic piping lengths and cable ties supported by successive wrappings from a roll of commercially available packaging shrink wrap plastic sheeting and lined with a layer of root retardant fabric. FIG. 1B is the same pallet from another perspective after assembly and charging with growth media. Representative elements that may be incorporated into the surface include conformable fabric strip dividers for altering horizontal profile or extending other compartmentalization or design effects are displayed.

FIG. 2 is a presentation of a comparison of functionality provided by integrated specialization for a number of portable platform components, compared with an alternative implementation(s) utilizing the generalized component.

FIG. 3 is an illustration of the single pallet portable platform component employed as a landscaping tool in several situations. These include techniques for replacing all or part of another modular component design element or some subregion(s) of an extended, non-modular region.

FIG. 4 illustrates the use of the surface of the growth media, the mulch or fabric cover and the separate template sheet as exists in the art as an extended or modularized template for assisting in the assembly and planting of the portable platform component.

FIG. 5 is a listing for one implementation of the template specification for a simple project, recorded and stored on paper medium and possibly encoded for storage on a non-volatile computer storage medium.

FIG. 6 consists of a set of schematic representations of a general process in the art for designing, installing or maintaining an intentional structure at different degrees of internal modularity.

FIG. 7,8,9 is three examples of preferred embodiments of the proposed inventive technique, based upon the process as diagrammed in FIG. 6.

### DETAILED DESCRIPTION OF THE INVENTION

A fundamental premise of the present invention is that the processes concerned with the design and installation and maintenance of any intentional horticultural structure utilizing any portable platform component may be improved and enhanced through making use of the optimization potential inherent in the fully implemented modularity of such a component. It is important that this fully implemented modularity be presented in the context of the most generalized, that is to say a minimally modified and maximally adaptable example of such a component.

The first consideration in choosing such a generalized component is in the choice of either a permanent and reusable base material, e.g. moldable plastic, or a material that will compost or degrade with time. The specialized characteristic of degradability reduces the reusability and durability of a general portable platform without affecting or influencing its pallet-like nature. Therefore, it seems most appropriate to choose a non-biodegradable material for the most generalized example of such a component.

A review of the literature reveals that there are several distinct ways to configure a generalized pallet-like base so that it will support and retain soil or other growth media within a single, rectangular platform area. The surface may be bounded by a permanent, fabricated and extended wall or rim, or such a rim may be constructed and attached as an impermanent structure. The impermanent structure may be removed or moved aside in some manner in order to facilitate the transfer of the media and any elements planted or installed on it to another location. The addition of a liner fabric or container to the surface of the platform before charging the compartment with media is also useful in case of either permanent or impermanent implementations of the compartment wall. This provides for more efficient and effective removal of the media and, if the fabric or container has been chosen with growth-influencing properties, can serve as a long-term provision for extended modularity in the design and installation and maintenance of any intentional horticultural structure. Specifically, installed components removed from their supporting platform can remain modular after relocation, the fabric or container serving as a means to remove the entire media/vegetative component for repair or replacement without significant disturbance to the rest of the structure or to the roots of the included vegetative elements. Portable platform components with prefabricated compartments or non-horizbntal or multiple prefabricated compartments (U.S. Pat. Nos. b 6,134,834,411,889) can be handled in the same manner, with an increase in the number and type of inner containers or fabric layers that must be constructed or assembled. The use of non-rectangular, or even non-regular, shapes for the platform base is documented in the literature, but the uses of non-regular, non-horizontal surface pallets with plant bearing compartmentalization that we have found in the literature have been restricted primarily to the placement of vegetatively enhanced edging elements (U.S. Pat. No. 644,989, US Patent Application20030089031).

The most complete and technically complex implementations of portable platform components can be found in the work concerned with the growth and transplant of large-area sod installations (U.S. Pat. No. 6,263,616), and the roof-top garden mode of landscaping for utilizing confined and limited use surface areas (U.S. Pat. No. 6,862,842). These take advantage of the prefabrication potentials of pallets to construct integrated care systems into the structure of the platforms and their support structures. Some of these care systems, as in the rooftop garden mode; remain integrated through the effective lifetime of the included portable platform components within the rigidly connected larger structure. Such care systems can be provided in many ways, none of which influence or adversely affect the form or primary functionality of the basic platform in use. For this reason, these will always be considered as modularizing options for all portable platform components without further mention and so simplify our attempt to generalize the portable platform component as a reference and illustration.

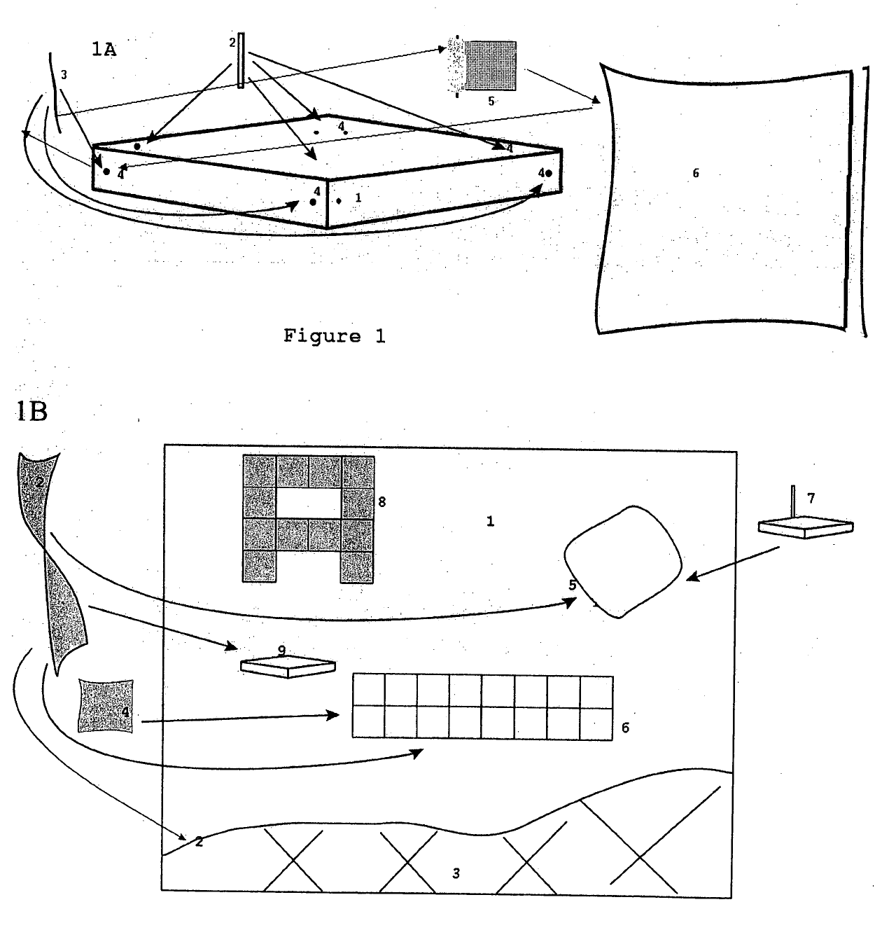

FIG. 1A is an exploded perspective view of a generalized portable platform component constructed from base pallet 1A-1 extended with plastic piping of variable length and number 1A-2 to act as a removable skeletal side reinforcement held in place with plastic cable ties 1A-3 passed through holes drilled at need through the corners or walls of the pallet 1A-4 supported by successive wrappings from a roll of commercially available packaging shrink wrap plastic sheeting 1A-5 and lined with a layer of root retardant fabric 1A-6.

The most neglected aspect of the portable platform component with respect to the component's modularity as represented in the literature of the art can be best described as a failure to recognize the role of aesthetic functionality and its relationship to modularity in the implementations represented. Every reference we have found in the literature employing portable platform components in the design or installation or maintenance of intentional horticultural structures exploits the identical aesthetic and functional characteristics of the components in an aggregate (at least 2 or more components) structure. This amounts to a plurality of similar objects to do a single job, often requiring the design and fabrication or prefabrication of specialized components. The inventive technique proposed relies on the unique possibilities of a single component in adapting each and every such component so employed most effectively as a module. This amounts to a single object doing many similar and disparate jobs without the imposition of additional prefabrication constraints. The inventive technique utilizes the available media supported and retained by any portable platform component surface compartment as an intentional horticultural surface that can be conformably or rigidly compartmentalized through the addition of non-vegetative elements of fabric, containers or other materials or objects not provided for in the original fabrication of the component. FIG. 1B is the generalized pallet of 1A from another perspective after assembly and charging with growth media 1B-1. Representative elements that may be incorporated into the surface include conformable fabric strip dividers 1B-2 for altering the horizontal profile of the installed component and separating it from the bare media or other support material 1B-3 that will be removed before installation 1B-4 or for extending other compartmentalization or design effects, flexible IB-5 and rigid 1B-6 additional compartmentalization with additional liner material filled with media and possibly other elements or compartments and liners, etc, an element stand 1B-7 to insert partially beneath the media surface for including interchangeable or single elements like a fountain , light component, or statue. Also shown are seeded tape strip segments formed in a pattern 1B-8, and a stand element 1B-9 for use as a relocatable support for other elements.

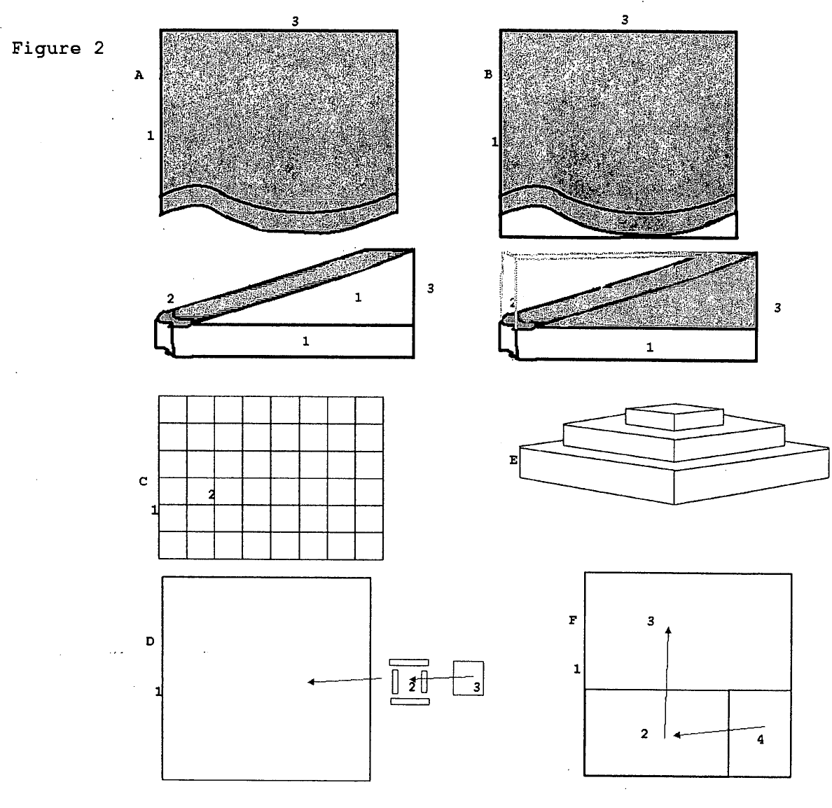

FIG. 2 is a presentation of a comparison of functionality provided by integrated specialization for a number of portable platform components or non-modular constructions, compared with an alternative implementation(s) utilizing the generalized component. FIG. 2A provides perspective views of a non-regular, non-horizontal growth media supporting unit 2A-1 and with an fabricated edging portion 2A-2 that can support media and vegetative elements. The component is meant to be placed in close proximity to similar units against a vertical barrier or wall, and is extended continuosly in the vertical direction across its back edge 2A-3. FIG. 2B is a generalized pallet implemented in an equivalent manner with a landscaped, sloped media unit 2B-1 with an extended wall 2B-3 made from a longer piping pieces and extended wrapping of the poly film reinforcing the retaining strength of the liner that has been cut overly large. A landscaped mound or ridge 2B-2 is included on the edge of the media unit and shaped on top to receive vegetative border elements. Additional edging blocks or beams, etc could be accommodated if desired 2B-4. FIG. 2C is a portable platform component with a rectangular shape 2C-1 containing rigid, prefabricated internal compartments 2C-2. Fic 2D is an eqivalent implementation using a generalized pallet. Internal fabric dividers 2D-1 are incoporated into the media surface 2D-2 and fabric liners 2D-3 are added to provide removable compartments. FIG. 2E provides and example of a terraced set of raised bed gardens (retained for example, either by edge units or landscaped soil). The same product realized through the use of a pallet base 2F is assembled by separate removal and stacking of appropriately thick and properly templated media unit (2F-1) and compartmentalizations 2F-2 2F-3 2F-4

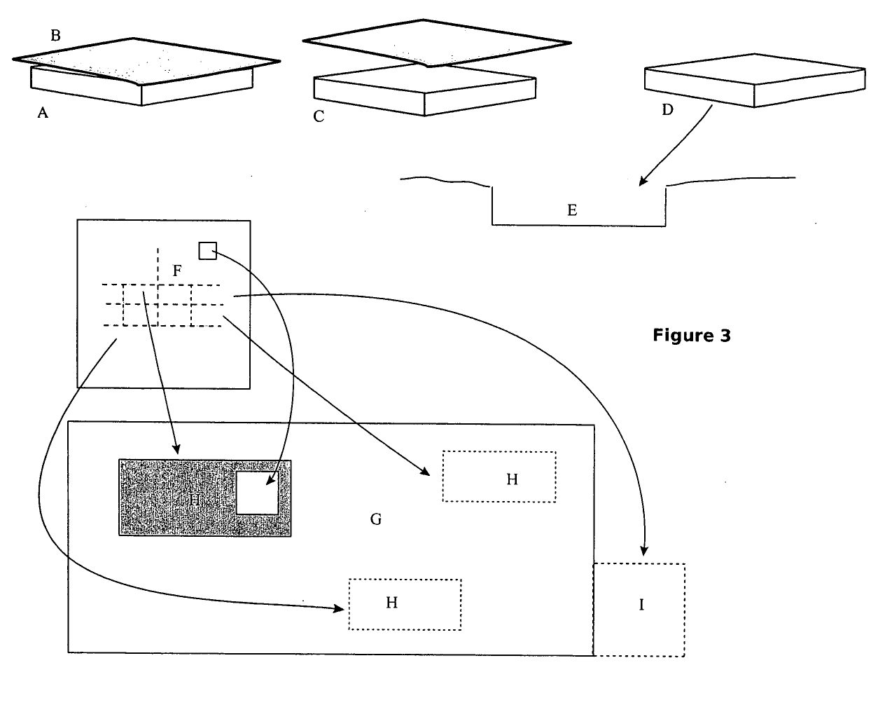

FIG. 3 illustrates the use of a single pallet component used as a horticultural or landscaping tool with considerable flexibility and facility. The primary component 3A may be installed in several modes: completely assembled including the pallet and liner 3B, partially disassembled by removal from the pallet while retaining the liner 3C and possibly installed in a recess 3E, and completely disassembled and installed on the surface 3D or in a recess 3E as a permanent part of the location. The full unit 3A or any chosen and differentiated sub-compartments 3F may be removed separately for use in repairing or replacing subregions of extended non-modular structures 3G, to repair or replace existing modular pieces 3H, or to extend the garden into previously non-utilized areas 31.

The most advanced use of the design capabilities of the portable platform media surface from the perspective of our inventive technique is found in (U.S. Pat. No. 6,134,834). This reference makes the most significant use of the design capabilities of the pallet surface with rigid prefabricated compartments and side modifications, but strictly requires at least two companion portable platform components, one with very restrictive composition requirements. The use of a very restricted pallet implementation in which aesthetic functionality of the surface is significant may also be found in (US Patent Application 20050120930). The portable platforms used within this reference are rigidly compartmentalized and utilized primarily to keep the vegetative elements from falling when the components are placed in a vertical arrangement. The design functionality is restricted to a single preferred use, i.e. advertising, and the aesthetic use of flowers is concerned with the message of the advertisement more so than with the conscious choice of flowers for their particular properties or characteristics. The possible addition of a reusable cover template is mentioned briefly without exposition.

It is also a matter to note that the increased modularity and adaptability provided by the inclusion of non-prefabricated compartmentalization as have been described and suggested do not a priori provide for the best nor most economical nor for the most aesthetically pleasing process or final structure, nor is any claim to this effect being made. The increased modularity and adaptability as described and presented extend and redefine the possibilities for optimization at the portable platform level and it is this increase in optimization options that provides the means for possibly improved and enhanced design and installation and maintenance of any intentional horticultural structure.

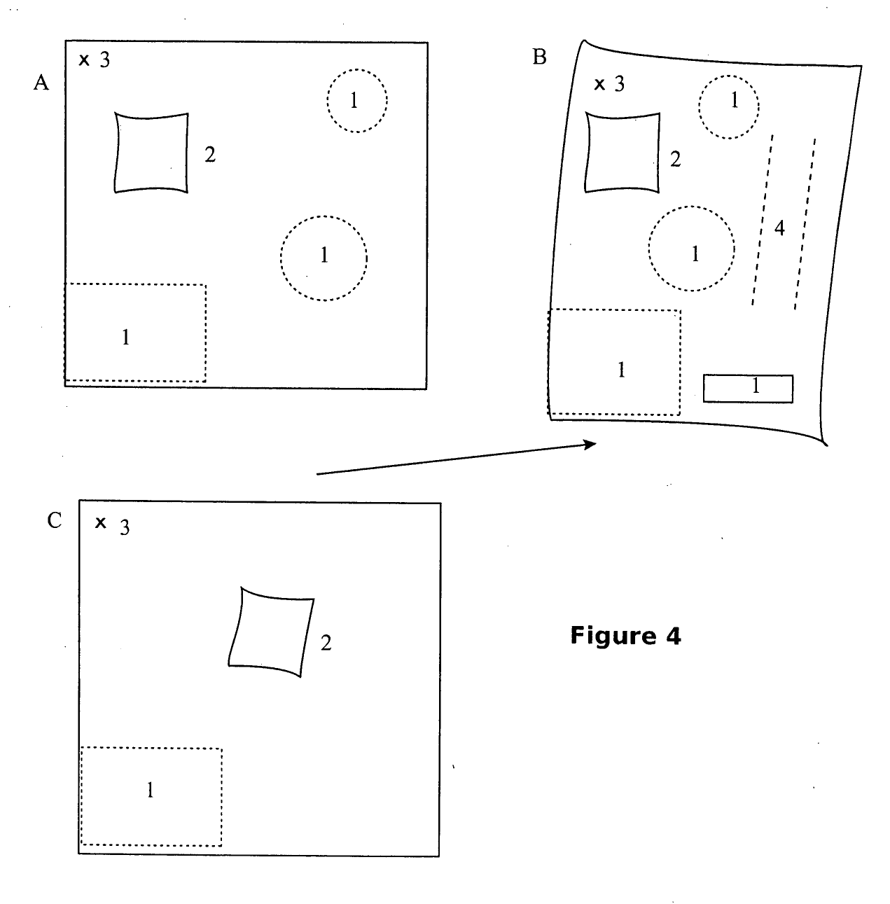

The use of templates with portable platform components implemented in the design and installation and maintenance of intentional horticultural structures is limited to reusable, removable templates of the type found in (U.S. Pat. No. 6,763,60), and (U.S. Pat. No. 5063708). The former invention utilizes a two-part template device, which separates the information necessary to reconstruct the intent of the design for any portable platform component, and therefore complicates the possible storage or retention of the design and installation information for future use. The reusability of the design template is mentioned, but not assured by any means that will promote survival of the physical elements involved. There is no method mentioned to flexibly modify such a template to respond to changing or unexpected constraints or innovations, nor is its participation in the larger design specifically mentioned. This seems to imply that the reusability is intended in the sense of reuse on the same extended project with an identical platform component and not for reuse on some other, future project. There is also no specific mention of the value of the template for a single portable platform as well as possibly the platform itself, in serving as a repair or replacement tool for the related or similar installed component. The work referenced in (U.S. Pat. No. 5,063,708) describes a technique for modular template segments made from an appropriate fabric used as a planting guide over an extended, non-component surface. There are no references to date that have been found that integrate the template into the surface of the growth media using non-prefabricated compartmentalization, as already noted. Similarly, we have not found references in the literature of the art that mentions the use of a template integrated in part or in whole within, or placed or marked upon, the fabric or materials which may serve as the growth-influencing cover for the assembled and then installed portable platform component. There is also no mention within the art of the possibility of combining these template possibilities within and across some combination of the proposed inventive idea. FIG. 4 illustrates the use of the surface of the growth media 4A, the mulch or fabric cover 4B and the separate template sheet as exists in the art 4C as an extended or modularized template for assisting in the assembly and planting of the portable platform component. Individual placement markers 4A-1 4B-1 4C-1 may be embossed or embroidered or otherwise marked. A sheet with written instructions, symbols or specifications 4A-2 4B-2 4C-2 to indicate elements included in the surface or complementary cover component of the possibly extended template may be attached. Perforations or cuts or pattern indicators 4B-4 to aid the placement of vegetative or other elements according to a plan or to achieve a desired effect may be made. Orientation marks or indicator 4A-3 4B-3 4C-3 can be added to the pallet, mulch/cover or template sheet as installation aids.

It is a matter to note that the increased modularity and adaptability provided by the inclusion of a single or multiple element template mechanism or device as have been described and suggested do not a priori provide for the best nor most economical nor for the most aesthetically pleasing process or final structure, nor is any claim to this effect being made. The increased modularity and adaptability as described and presented extend and redefine the possibilities for optimization at the portable platform level and it is this increase in optimization options that provides the means for possibly improved and enhanced design and installation and maintenance of any intentional horticultural structure.

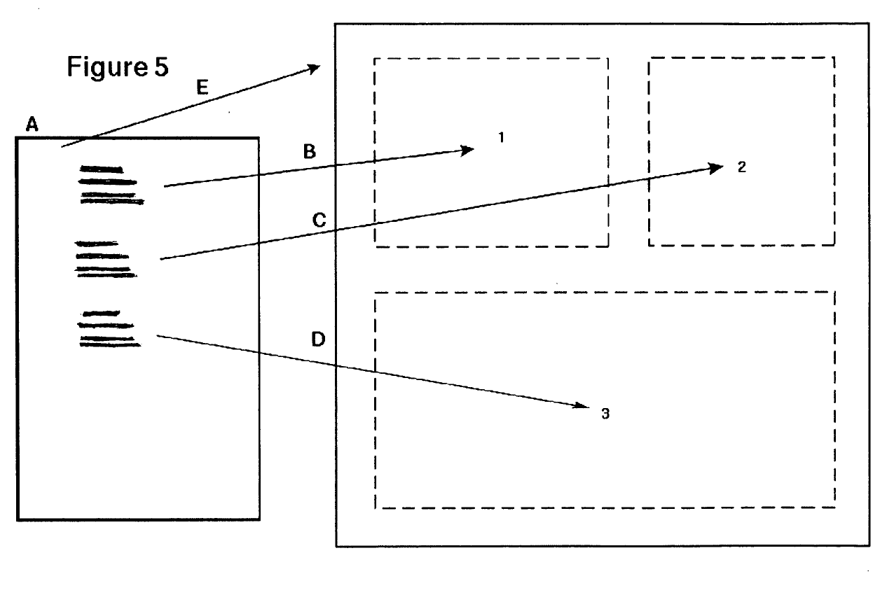

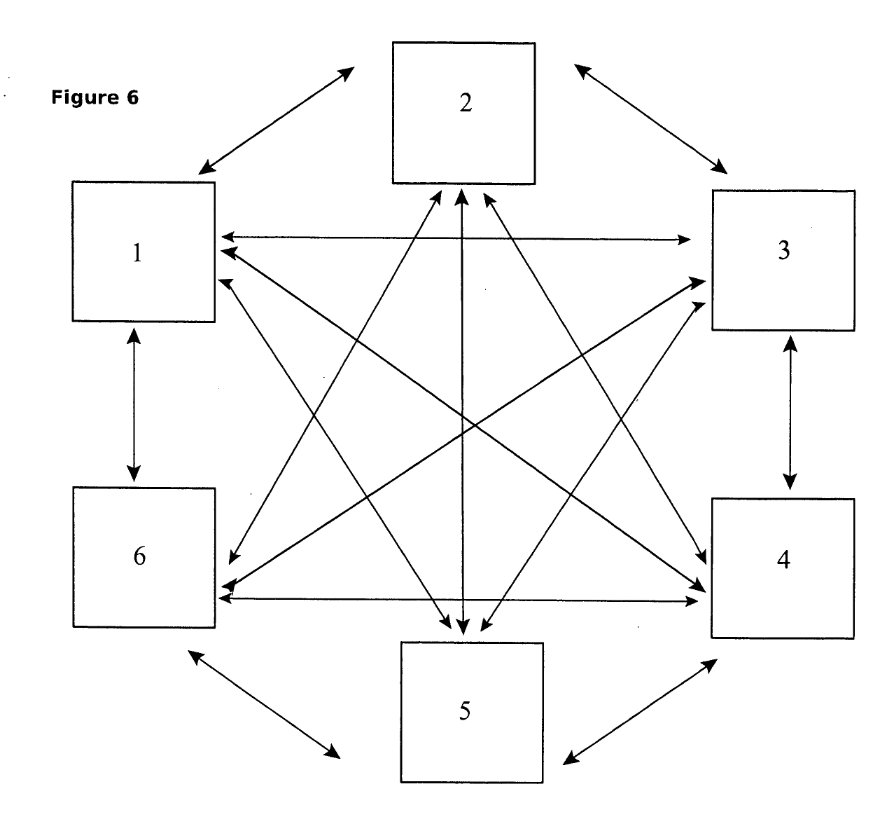

There are no references or citations relevant to the method of a design or template specification as represented in the claims of this application found in our review of the relevant art. The methods of a modular template for use on an extended, intentionally non-modular location and a reusable template specifically for use with portable platform components have been cited above. These methods, and methods related to them, make no provision for the separate storage or remembrance of the information required to construct or assemble a new template according to the same specifications. There is no method to cite providing for inventory, labor and related information stored or remembered in some way, perhaps with the template information, in order to completely determine the set of specifications necessary to replace, transfer or install the exact same intentional horticultural structure in whole or in part, modified or unchanged, in the same location or some other location which may be made suitable for its installation. There is no method to cite providing for a technique to include the existing, prior or possible modularity and compartmentalization in a dynamic manner so that the variables associated with resources and constraints influencing the intent of the horticultural structure may be optimized more effectively, therefore improving and enhancing the design and installation and maintenance of any such structure. The inventive technique provides a simple, logical and effective means to integrate modular and non-modular aspects of the landscaping process. FIG. 5 is a listing for one representative implementation of the template specification for a simple project. Recorded. It has been recorded and stored on paper medium 5A and placed in a file cabinet for future reference. It has additionally been encoded and possibly encrypted after transfer to a computer for storage on a non-volatile computer storage medium. Identifications of groupings of items corresponding to modular (5B 5C 5D) and extended non-modular locations 5E within the horticultural structure are indicated The actual cost with respect to any resource or constraint can be accurately and effectively calculated if large projects are decomposed into smaller, integrated and reasonably self-contained sub-projects. The portable platform component implementations that have been discussed are a very economical and adaptable means to turn any extended intentional horticultural structure, or garden, into a related set of ordered, oriented and intentionally designed sub-gardens. Each one of these has a very definite internal modularity, cost of assembly and construction and care according to any processes that can be manually or mechanically automated. Such processes are facilitated by a menu, or list or representation of pieces and positions and a means to alter the relationships and types of pieces represented. This in turn provides for calculation of the cost of each sub-unit in any of various modes of construction and installation, and other functionality relevant to specific projects. These could be mental calculations and visualizations for a simple project, perhaps those involving a single or a few portable platform component(s), or complex computer-aided and automated activities. It is once more not a priori certain that implementing a template specification will save resources, or time, or labor, etc. The inventive technique provides the means for improvements and enhancements which are realized in the form of increased optimization potential for the design or installation or maintenance of intentional horticultural structures. Specifically, the inventive technique is concerned with the deliberate and orderly preservation of any and all information relevant to the satisfaction of the intent of any horticultural structure in order to guarantee reproducibility of the structure in full or in part at any location capable of receiving it or being prepared by methods of the art to receive it. The technique also completes the integration of modular and non-modular approaches to the design and installation and maintenance of intentional horticultural structures by considering both portable platform components based contributions and extended non-modular areas of the structure as interchangeable and convertible aspects of the larger structure. This interchangeability permits the design to proceed with less consideration of the constraints involved with realizing complex or detailed functionality.

There are no specific references found in the literature of the art addressing a general method comprising 6 (six) steps used iteratively and with a dynamic order applied as needed. The complex configurations provided for by many of the interlocking, identical portable platforms within the literature, as in the turf systems or roof top installations described already, must have proceeded from some ordered and structured considerations but the aesthetic functionality has not been not provided for beyond that afforded by the plural and reproducible nature and similarity of the portable platform components employed.

FIG. 6 consists of a schematic representation of a general process in the art for designing, installing or maintaining an intentional structure at different degrees of internal modularity. The steps are arranged in a ring to indicate the dynamic ordering possibilities. Each step is connected by bi-directional arrows to each of the other steps to indicate the possible dynamic flow of the steps in response to the planned circumstances in a scheduled manner or to address any unexpected new constraints or resources as they arise. The number order of the steps indicates the usual flow for a new structure at a new location. The steps could begin, for example, at step 3 when a resource shortage forces a reconsideration of the pallet and other components chosen, step 4, or back to the design step at 1 to adjust the parameters to accommodate the shortage. It might also proceed instead to step 2 in an attempt to rearrange or reallocate the existing resources more efficiently, compromising on some other aesthetic or pragmatic factor. A new design might be stimulated by the availability of a new type of component, or a redesign and reinstallation of portions of the main structure might be considered. Again, the steps will proceed in response to the circumstances as they arise in order to most effectively and efficiently satisfy the intent of the design.

Preferred Embodiments

An example of the application of the present invention is provided below in order to indicate the broad range of intentional horticultural structures that may benefit from the employment of the inventive techniques.

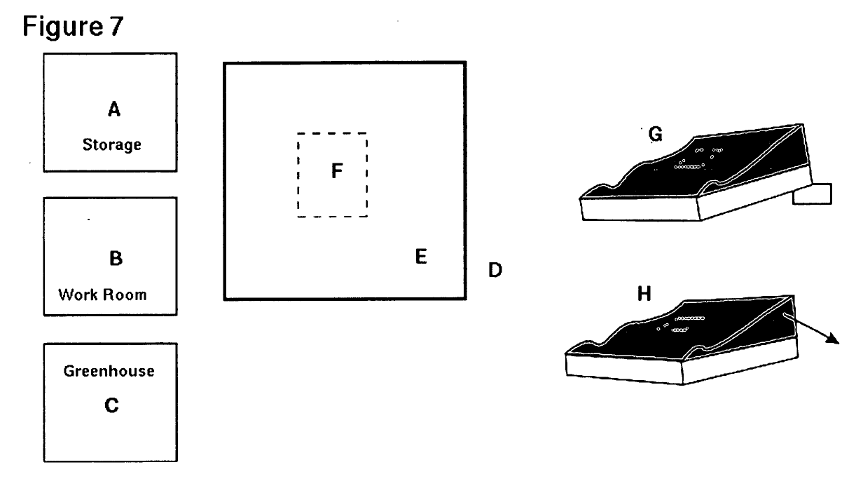

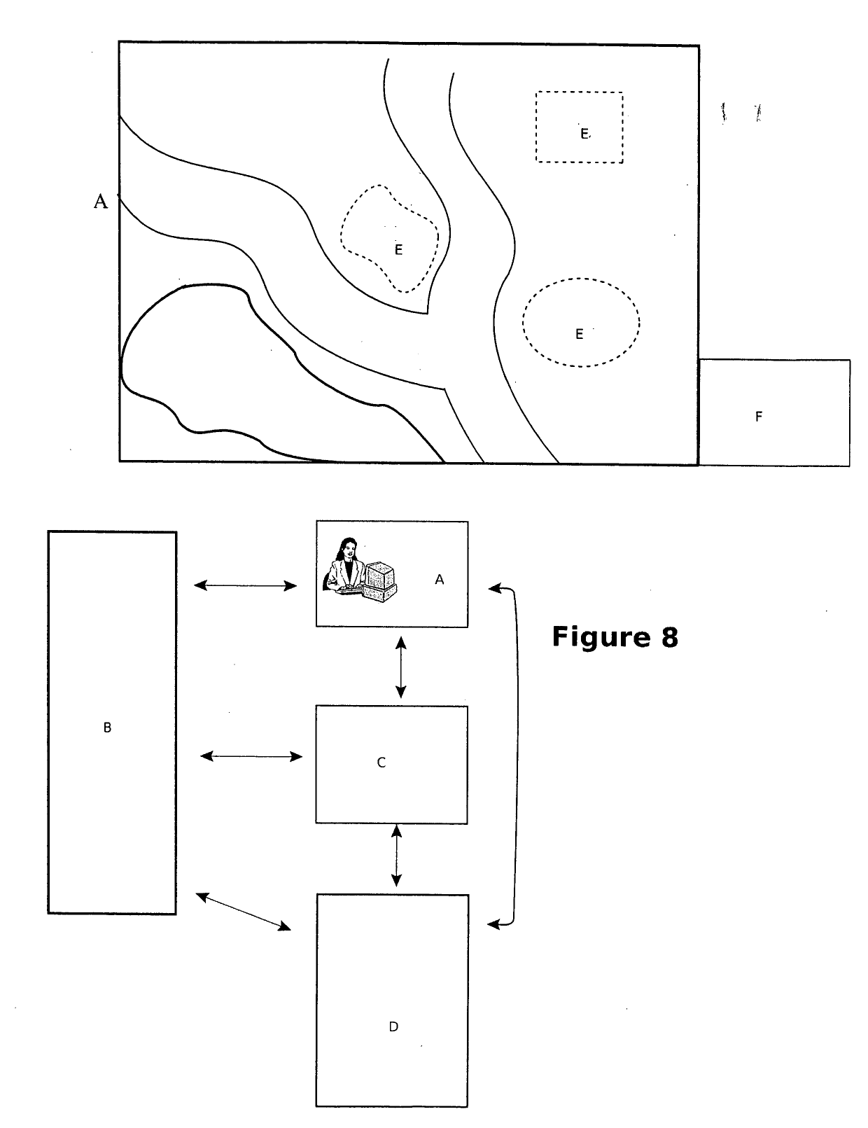

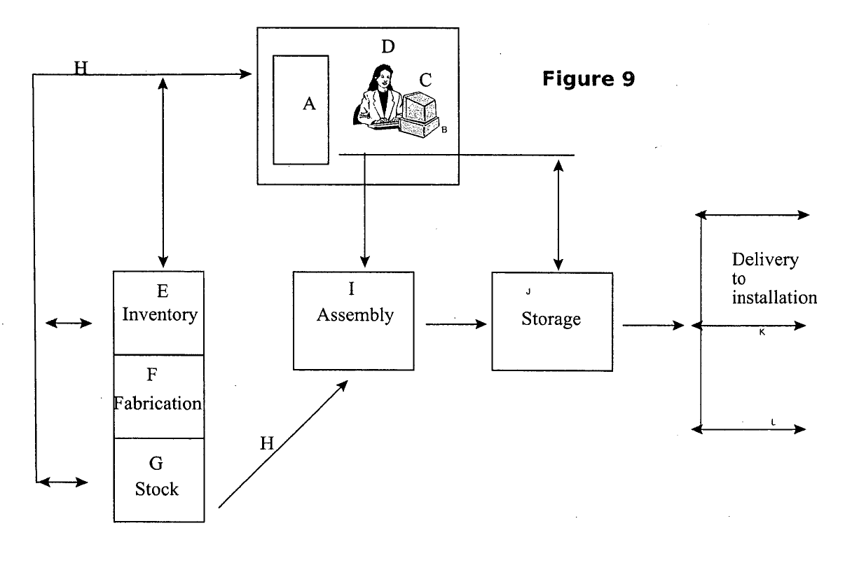

FIG. 7 illustrates a service established and organized to provide single pallet gardens for special festive or solemn occasions, e.g. weddings, anniversaries, births, birthdays, funerals, graduations, etc. A storage building 7A and a work room 7B with a computer and associated disk storage facility, paper copy filing units, and a drafting or design area provide for the design, inventory, supply and assembly of these gardens as required. A greenhouse facility 7C is attached to the facilities to provide a regular supply of vegetative elements. An illustrated catalog of available designs is provided to the client for the selection of an appropriate standard design. The appropriate pallet 7D is assembled with an appropriate primary design compartment or compartments 7E and (a) secondary compartment(s) 7F for use in including custom elements associated with information or preferences for the event or persons concerned. The pallet garden is delivered to the location of a ceremony or event associated with the occasion and is displayed on an external stand or support for viewing 7G. The garden is later transported for installation on the pallet or within the ground in a modular (with retardant surface layer) or permanent (no layer) manner either in a new location or as part of an existing extended garden 7H created over time from such units. The pallet and liner and a copy of the listing of the pallet specification for the garden are included in the delivery. Repairs, modifications or extensions may be made over time, or provided as an extension of the original service.

FIG. 8 provides an example of an approach to the maintenance and extension of an existing public space 8A. The space is subject to erosion and damage from weather and use and must be constantly repaired to be kept in its original condition, preferably with no major disruption of the park's availability to the public. Occasionally new land is added to the space, or buildings and other structures are removed, added or modified. The maintenance team has established a workshop 8A and a small greenhouse 8B for storing, growing and assembling the components and elements needed to perform repairs and upgrades as they are required or scheduled. The main template specification is stored on a computer facility for ease of access and modification. A large number of identical portable platform components, stored in D, and accessory elements in storage C, are kept on hand for multiple and extended projects and repairs that require more than a single pallet to be satisfied within the required time frames. The regions 8E are replaced individually as single units to prevent large disruptions of park activity. The extensions 8F can be incorporated into the template specification before they are fully designed and assembled, facilitating the process of integrating them into the public space.

FIG. 9 is an example of the inventive technique applied in a complex environment. The embodiment would require investing heavily in available technology in order to take full advantage of the template specification and the incorporated modularity of the design. We will restrict the discussion of the embodiment to the assigned process order from the statement of the inventive technique for the sake of brevity and simplicity. A computer and associated storage unit 9A are connected to a high-resolution video display 9C and other peripherals 9B that may facilitate the design process. Sophisticated software with capabilities related to Computer Aided Design (CAD) and Geographic Information Systems (GIS), among other technologies, contains digitized maps and other information related to the locations at which all intentional structures are to be installed. The designers, or unit operators, 9D may work on multiple projects simultaneously, and the rest of the embodiment steps are similarly equipped and prepared. As design elements are added or decisions are made and saved by the design unit operator to the full template specification on the computer storage unit 9A they are immediately implemented in the other units. The process for a parallel set of components and elements will be traced. Specifically, there will be seen by one skilled in the art to be no difference in the manner in which food-based structures and decorative or ornamental structures proceed through the processes. The food-based structure is a greenhouse-based farm installation in which plants have been chosen and arranged to optimize the resources involved in the care of different species in one location with a fixed and automated system for maintenance of the plants. The aesthetic structure is assumed to be a large project involving architectural units as well as strictly landscaping units. The design is saved by the operator 9D from a 3 dimensional rendering on 9C which reflects the location topography. The computer 9A sends signals as needed to begin automated fabrication and production 9F of required platform components using materials from Inventory 9E that may not exist in stock 9G. The robotic transfer system 9H that joins all the units carries the materials from storage to fabrication and then to the assembly area 91. The robotic transfer unit retrieves all elements and media from storage and the required vegetative components and elements are retrieved. The GIS capabilities integrated into the master program provide the functionality that permits the retrieval, transfer, placement and storage of all elements and completed platform components or non-modular elements by the robotic systems. The need for physical templates has been removed through the use of virtual template creations within the computer via the specification and its georeferenced nature. The construction, installation and delivery schedules as represented by the template are implemented by the computer such that all components and elements and additional resources are in the proper place at the proper time. The use of controlled storage in the automated greenhouses 9J and the correct routing of the finished elements at the departure points 9K and 9L for each project is the completed and the elements and components are delivered for installation. The installation procedures could also proceed in the same computer-controlled automated maner if the facilties exist or can be provided at the final location. As in the other implementations, the steps may proceed from any point to any point depending upon the stimulus or need.

The inventive technique has been described herein relative to its preferred embodiment or embodiments, it is of course contemplated that modifications of, and alternatives to, this embodiment or these embodiments, such modifications and alternatives obtaining the advantages and benefits of this invention, will be apparent to those of ordinary skill in the art having reference to this specification. It is contemplated that such modifications and alternatives are within the scope of this invention as subsequently claimed herein.

What is claimed is:

1) A method for implementing a system to improve and enhance the design, installation, maintenance, including modification and/or extension, of any intentional horticultural structure through a process utilizing a single portable platform component and a design template specification
wherein said single portable platform component contains at least one surface compartmentalization capable of retaining and supporting growth media and accessory elements
and wherein said single portable platform component may be augmented by the addition of a surface layer, cover, or container to facilitate possible integral removal of said media and accessory elements from said compartmentalization,
and wherein said layer, cover, or container may also have characteristics to influence vegetative growth
and wherein said cover, layer, or container is to be charged or loaded with appropriate growth media to support the placement and planting and
care of said vegetative and accessory elements
and wherein said media may have inserted beneath or in or placed on its surface additional rigid or conformable materials additional non-vegetative aesthetic or functional elements, fabricated into nor provided for explicitly in the fabrication of portable platform component, to provide for additional compartmentalization or pragmatic or aesthetic functionality or to serve as a full or partial template in order to facilitate the placement and orientation of the portable platform component and any vegetative and non-vegetative accessory elements
and wherein said media may be provided with a permanent impermanent cover or coating which may have characteristics influence vegetative growth
and wherein said cover or coating may have integrated into or added onto its structure or placed onto added to its surface additional rigid or conformable materials or additional non-vegetative aesthetic or functional elements or layers or covers to provide for additional compartmentalization or pragmatic or aesthetic functionality or to serve as a full or partial template in order to facilitate the placement and orientation of said portable platform component and said vegetative and non-vegetative accessory elements
wherein said template specification consists of a mental, physical, graphical or textual listing or catalog containing all information necessary and related to realizing the intent of the horticultural structure
and wherein said template specification may provide all the information necessary and related to the assembly or construction of a template or design guide for the complete intentional horticultural structure
and wherein said template specification or design guide may reflect or may be modified to reflect any desired, existing or former internal structure or design and modularity or compartmentalization of the intentional horticultural structure
and wherein said template specification may in turn be modified
represent any alteration of said internal structure or design and modularity or compartmentalization
and wherein the template specification may provide for the assembly or construction of templates for said internal compartments or modules
and wherein said specification may be remembered, stored or coded in some non-volatile manner to facilitate the reconstruction, modification, extension, reproduction or relocation of the intentional horticultural structure
wherein the steps for implementing said processes consist of:
1) constructing or determining an initial template specification for a location at which an intentional horticultural structure exists to be maintained or modified or repaired or at which a new structure is to be created
2) modifying said template specification as necessary to reflect the constraints and available resources related to the design and functional intent of the horticultural structure
3) creating or assembling or constructing templates for the intentional horticultural structure or the portable platform component as required to satisfy
4) the design and functional intent of the horticultural structure according to the template specification
5) selecting and assembling or fabricating the appropriate portable platform module and all accessory elements necessary to satisfy the design and functional intent of the horticultural structure according to the template specification
6) storing or preserving the assembled and prepared portable platform component under controlled conditions at a remote location until the appropriate time for its delivery for use in accord with the template specification and the functional intent of the horticultural structure
7) delivering and installing the portable platform component and all additional accessory elements for the intentional horticultural structure in accord with the template specification
and wherein said processes may be initiated at or proceed to any step, without dependence upon the order as listed, as required to satisfy the intent of any intentional horticultural structure
and wherein said processes may proceed iteratively through any sequence of the listed steps, without dependence upon the order as listed, as required to satisfy the intent of any
intentional horticultural structure
wherefore as the separate and combined techniques as herein described and claimed increase the internal modularity and organization of any portable platform component through the implementation of the non-prefabricated compartmentalization methods and extended template methods there is a corresponding increase in the potential for optimization with respect to all constraints and resources associated with or influencing the intent of any horticultural structure and
wherefore as a consequence of the increased organizational and conceptual benefits realized by the implementation of a method employing a template specification within the design and installation and maintenance processes there is a corresponding increase in the potential for optimization with respect to all constraints and resources associated with or influencing the intent of any horticultural structure
and the separate and combined increase in optimization potential provides the means whereby improved and enhanced design, installation and maintenance of any intentional horticultural structure may be realized.

2) The method as set forth in claim 1 wherein the method is extended to include possibly a plurality of identical base portable platform components

3) The method as set forth in claim 2 wherein the method is extended to include possibly a plurality of distinct base portable platform components and possibly an identical plurality of each distinct base portable platform component
